(19) United States
(12) Patent Application Publication
(10) Pub. No.: US 2014/0206260 A1
(43) Pub. Date: Jul. 24, 2014

(54) SUBSTANCE AND RELATED METHODS FOR CLEANING INSTRUMENTS

(71) Applicant: Phillip Jason Everly, Hollywood, CA (US)

(72) Inventor: Phillip Jason Everly, Hollywood, CA (US)

(21) Appl. No.: 13/745,355

(22) Filed: Jan. 18, 2013

(51) Int. Cl. C09K 3/14; B24B 1/00

(52) U.S. Cl. CPC C09K 3/1481; B24B 1/00
USPC 451/28; 51/308; 51/306; 51/304; 51/307; 51/309

(57) ABSTRACT

Disclosed are substances and methods of cleaning musical instruments which are capable of abrading or removing dirt and grime from instrument surfaces or cracks. In one embodiment, the substance comprises a plastic flexible material mixed with at least one abrasive material. In one method of use: (1) a lubricant (such as a water/detergent solution) is gently sprayed on to a small area on the surface of a musical instrument; (2) the substance is, with light to medium pressure, rubbed across the lubricated surface multiple times until the area is visibly clean or smooth to the touch; and (3) steps one and two are repeated until the whole instrument is cleaned or smoothed.

### CROSS-REFERENCE TO RELATED APPLICATIONS

This application claims the priority of U.S. Prov. Pat. App. Ser. No. 61/588,145 (filed on Jan. 18, 2012) entitled “Substance and Related Methods for Cleaning Instruments” and its contents are incorporated by reference in their entirety.

### STATEMENT REGARDING FEDERALLY SPONSORED RESEARCH OR DEVELOPMENT

Not applicable.

### BACKGROUND OF THE INVENTION

1. Field of Invention

This invention is in the field of substances and related methods of cleaning musical instruments.

2. Background

In many instances, musical performances involve the operation of a musical instrument. Sometimes, musical performances are live, wherein the musical instrument is seen by an audience. In such circumstances, a performer may be desirous of having the musical instrument be clean so that it has a pleasant appearance. Other instances also arise wherein musical instruments are preferably clean. For instance: sellers of new or used musical instruments endeavor to present clean and pleasantly appearing instruments to potential buyers. For another instance: dirty and unpleasant appearing musical instruments are anathema to some musicians. Accordingly, there is need for substances and methods of cleaning musical instruments.

Until now, most musical instruments have been cleaned via application and subsequent removal of cleaning solutions, which solutions typically comprise water and other chemicals configured to remove dirt and other grime from musical instrument surfaces when applied and buffed away. For instance, U.S. Pat, No. 4,687,591 (issued Aug. 18, 1987) discloses an aqueous composition for cleaning cymbals, wherein the composition is sprayed on a cymbal and buffed off. See also U.S. Pat. No. 7,282,100 (issued Oct. 16, 2007). For another instance, many instruments are cleaned using a solution of isopropyl alcohol and water that is buffed away using a towel or chamois. Although useful for cleaning many surfaces, said cleaning solutions are not entirely adequate in every circumstance for cleaning musical instruments. Specifically, musical instrument surfaces may feature: (1) dirt or grime filled cracks wherein applied cleaning solutions plus buffering cannot entirely penetrate and remove the dirt and grime that are deeper than the instrument's surface; (2) dirt, grime or other surface protrusions that need to be abraded rather than buffed from the musical instrument's surface; or (3) hard substances which may scratch or otherwise tarnish the instrument's surface when buffed thereacross. Accordingly, there is still a need for substances and methods of cleaning a musical instrument which are capable of abrading or removing dirt and grime from instrument surfaces or cracks without scratching or tarnishing the instrument's surfaces.

U.S. Pat. No. 5,476,416 (issued Dec. 19, 1995), U.S. Pat. No. 5,928,064 (issued Jul. 27, 1999), U.S. Pat. No. 6,241,579 (issued Jun. 5, 2001), or U.S. Pat. No. 8,025,557 (issued Sep. 27, 2011) disclose substances comprising soft flexible plastic materials mixed with abrasive materials for cleaning automobile surfaces (such substance is known colloquially as automotive day). However, such substances are too hard and abrasive for use on musical instruments, which frequently have surfaces that are easily scratched or damaged. Thus, the need still remains for there remains a need substances and methods of cleaning a musical instrument which are capable of abrading or removing dirt and grime from instrument surfaces or cracks without scratching or tarnishing the instrument's surfaces.

### SUMMARY OF THE INVENTION

An objective of this specification is to disclose substances and methods of cleaning musical instruments which are capable of abrading or removing dirt and grime from instrument surfaces or cracks without scratching or tarnishing the instrument's surface. In one embodiment, the substance is a plastic flexible material mixed with at least one abrasive material. In one method of use: (1) a lubricant (such as a water/detergent solution) is gently sprayed on to a small area on the surface of a musical instrument; (2) the substance is, with light to medium pressure, rubbed across the lubricated surface multiple times until the area is visibly clean or smooth to the touch; and (3) steps one and two are repeated until the whole instrument is cleaned or smoothed.

### BRIEF DESCRIPTION OF THE FIGURES

Other objectives of the disclosure will become apparent to those skilled in the art once the invention has been shown and described. The manner in which these objectives and other desirable characteristics can be obtained is explained in the following description and attached FIGURES in which:

FIG. 1 is a flow chart of a preferable method of using a substance that is capable of abrading or removing dirt and grime from instrument surfaces or cracks without scratching or tarnishing the instrument's surface.

It is to be noted, however, that the appended FIGURE illustrates only a typical embodiment of this invention and is, therefore, not to be considered limiting of the invention's scope, for the invention may admit to other equally effective embodiments that will be appreciated by those reasonably skilled in the relevant arts. That is to say, the FIGURE is only representative of one embodiment of the invention.

### DETAILED DESCRIPTION OF PREFFERED EMBODIMENTS

Further objectives and advantages of the present invention will become apparent as the description proceeds. To gain a full appreciation of the scope of the present invention, it will be further recognized that various aspects of the present invention can be modified and/or combined to make desirable embodiments of the invention. Unless defined otherwise, all technical and scientific terms used herein have the same meaning as commonly understood by one of ordinary skill in the art to which this invention belongs. Where a term is provided in the singular, the plural of that term is also contemplated.

Disclosed are substances and methods of cleaning musical instruments which are capable of abrading or removing dirt and grime from instrument surfaces or cracks without scratching or tarnishing the instrument's surface. In a preferred embodiment, the substance is comprised of a plastic flexible material and at least one abrasive material. The plastic flexible material may be clay, kaolin clay, oleic acid plus rubber or a petroleum resin (e.g., polybutene), The abrasive material may be silica (sand), calcium carbonate, alumina ceramics, silicon carbide abrasive, or the like. The substance may preferably and generally be made according to the disclosure of U.S. Pat. No. 5,476,416 (issued Dec. 19, 1995), U.S. Pat. No. 5,928,064 (issued Jul. 27, 1999), U.S. Pat. No. 6,241,579 (issued Jun. 5, 2001), or U.S. Pat. No. 8,025,557 (issued Sep. 27, 2011). However: (a) the plasticity of the resulting substance may preferably be between two-hundred sixty (260) and two-hundred eighty (280) millimeters per cubic centimeter instead of between three-hundred twenty (320) and three-hundred forty (340) millimeters per cubic centimeter; and (b) the density of the abrasive materials in the substance may preferably be between two (2.000) and two and ten thousandths (2.010) grams per cubic centimeter instead of between two and twenty thousandths (2.020) and two and forty thousandths (2.040) grams per cubic centimeter.

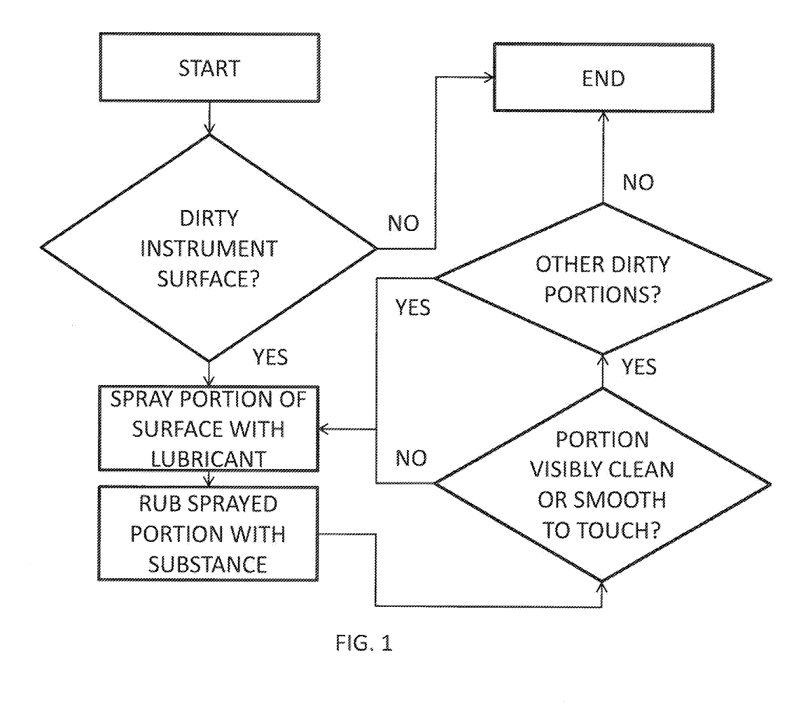

Operably, the disclosed substance may be used to clean the surfaces of a musical instrument. FIG. 1 discloses a flow chart of one method of using the disclosed substances to clean a musical instrument. Referring to that FIGURE, a musical instrument is obtained and its surfaces are inspected for dirt or other grime, wherein IF the surface is dirty, THEN a portion of the surface is (1) sprayed gently with a lubricant (such as a water/detergent solution) and (2) the sprayed portion is rubbed, with light to medium pressure, multiple times with the substance. Still referring to the FIGURE, after the area has been rubbed with the substance, the rubbed portion is inspected wherein IF the portion is still dirty, THEN the above described step is repeated, ELSE other portions of the instrument surface are inspected for dirt and grime wherein IF other portions are dirty, THEN the above described step is repeated, ELSE the instrument is clean and the process complete. Suitably: the plasticity of the substance allows penetration of surface cracks by the substance; the plasticity of the substance allows absorption of hard particles on an instruments surface by the substance; and the density of abrasive materials allows the substance to abrade surface protrusions without damaging the surface of the instrument.

Musical instruments which can be cleaned using said substance according to the disclosed methods may include: bagpipes; banjos; bass drums; bassoons; bells; bongos; castanets; cellos; clarinets; clavichords; conga drums; contrabassoons; comets; cymbals; double basses; dulcian; dynamophones; flutes; flutophones; glockenspiels; gongs; guitars; harmonicas; haprs; harpsichords; lutes; mandolins; maracas; metallophones; music boxes; oboes; ondes-martenots; pianos; recorders; saxophones; shawms; snare drums; steel drums; tambourines; theremins; triangles; trombones; trumpets; tubas; ukuleles; violas; violins; xylophones; or zithers.

This specification and the appended FIGURES illustrate only typical embodiments or principles disclosed in this application, and therefore, are not to be considered limiting of its scope, for the invention may admit to other equally effective embodiments that will be appreciated by those reasonably skilled in the relevant arts. Any invention disclosed by this specification is defined by the claims.

The invention claimed is:

1. A substance for cleaning musical instruments, comprising:
a plastic flexible material; and,
an abrasive material.

2. The substance of claim 1 wherein the plastic flexible material is selected from the group consisting essentially of any of the group of materials which are clay, kaolin clay, oleic acid, or a petroleum resin (e.g. polybutene).

3. The substance of claim 2 wherein the plasticity of the resulting substance is between two-hundred sixty (260) and two-hundred eighty (280) millimeters per cubic centimeter.

3. The substance of claim 3 wherein the abrasive material is selected from the group consisting essentially of any of silica (sand), calcium carbonate, alumina, ceramics, or silicon carbide abrasive.

5. The substance of claim 4 the density of the abrasive materials in the substance is between two (2.000) and two and ten thousandths (2.010) grams per cubic centimeter.

6. The substance of claim 1 wherein the abrasive material is selected from the group consisting essentially of any of silica (sand), calcium carbonate, alumina, ceramics, or silicon carbide abrasive.

7. The substance of claim 6 the density of the abrasive materials in the substance is preferably between two (2.000) and two and ten thousandths (2.010) grams per cubic centimeter.

8. A method of cleaning a musical instrument, comprising the steps of inspecting the musical instrument for grime;
identifying a portion of the surface containing grime;
spraying a lubricant on the portion of the surface containing grime;
rubbing the portion of the surface containing grime with a substance comprising:
a plastic flexible material; and,
an abrasive material.

9. The method of claim 8 wherein the plastic flexible material is selected from the group consisting essentially of any of the group of materials which are clay, kaolin clay, oleic acid, or a petroleum resin (e.g. polybutene).

10. The method of claim 9 wherein the plasticity of the resulting substance that is rubbed on the porion of the surface containing grime is between two-hundred sixty (260) and two-hundred eighty (280) millimeters per cubic centimeter.

11. The method of claim 10 wherein the abrasive material is selected from the group consisting essentially of any of silica (sand), calcium carbonate, alumina, ceramics, or silicon carbide abrasive.

12. The method of claim 11 the density of the abrasive materials in the substance that is rubbed on the portion of the surface containing grime is preferably between two (2.000) and two and ten thousandths (2.010) grams per cubic centimeter.

13. The method of claim 8 wherein the abrasive material is selected from the group consisting essentially of any of silica (sand), calcium carbonate, alumina, ceramics, or silicon carbide abrasive.

14. The method of claim 13 the density of the abrasive materials in the substance that is rubbed on the portion of the surface containing grime is preferably between two (2.000) and two and ten thousandths (2.010) grams per cubic centimeter.

15. A method of using automotive detailing clay to clean a musical instrument, comprising the steps of:
inspecting the musical instrument for grime;
identifying a portion of the surface containing grime;
spraying a lubricant on the portion of the surface containing grime;
rubbing the portion of the surface containing grime with a substance comprising:
a plastic flexible material; and,
an abrasive material.

16. The method of claim 15 wherein the plastic flexible material is selected from the group consisting essentially of any of the group of materials which are clay, kaolin clay, oleic acid, or a petroleum resin (e.g. polybutene).

17. The method of claim 16 wherein the plasticity of the resulting substance that is rubbed on the portion of the surface containing grime is between two-hundred sixty (260) and two-hundred eighty (280) millimeters per cubic centimeter.

18. The method of claim 17 wherein the abrasive material is selected from the group consisting essentially of any of silica (sand), calcium carbonate, alumina, ceramics, or silicon carbide abrasive.
